(19) United States
(12) Patent Application Publication
(10) Pub. No.: US 2005/0171817 A1
(43) Pub. Date: Aug. 4, 2005

(54) Method and system for patient medical information management

(76) Inventors: Ranjan Sachdev, Bethlehem, PA (US); Richard Joseph McCormick, Stewartsville, NJ (US)

Correspondence Address: Daniel H. Golub, 1701 Market Street, Philadelphia, PA, 19103, US

(21) Appl. No.: 11/021,762

(22) Filed: Dec. 23, 2004

Related U.S. Application Data
(60) Provisional application No. 60/532,369, filed on Dec. 24, 2003.

(51) Int. Cl. G06F 17/60

(52) U.S. Cl. 705/3

(57) ABSTRACT

A method for generating a treatment plan for a patient history information is provided to a physician in electronic form. Patient examination information is provided in electronic form. Patient diagnostic test results is provided in electronic form. A plurality of candidate diagnoses is automatically selected using the patient history information, patient examination information and patient diagnostic test information. A plurality of treatment plans is presented to the physician from a predefined list of treatment plans, wherein each of the plurality of treatment plans is comprised of at least one of a medical test, a medical procedure, a prescription, a pre-certification, a school excuse or a work excuse, and wherein each of the plurality of treatment plans corresponds to at least one of the plurality of candidate diagnoses. A treatment plan is selected from the plurality of treatment plans. At least a portion the selected treatment plan, is executed.

### REFERENCE TO RELATED APPLICATIONS

This application claims the benefit of U.S. Provisional Application No. 60/532,369 filed on Dec. 24, 2004, entitled “Method and System for Patient Medical Information Management.”

### FIELD OF THE INVENTION

This invention relates to a method for generating a treatment plan for a patient through the generation of electronic medical records. It also relates to a method for facilitating treatment of emergency room patients through the transfer of a patient's electronic medical records to physicians at remote locations.

### SUMMARY OF THE INVENTION

The present invention provides for a method for generating a treatment plan for a patient. Patient history information is provided to a physician in electronic form. Patient examination information is provided in electronic form. Patient diagnostic test results is provided in electronic form. A plurality of candidate diagnoses is automatically selected using the patient history information, patient examination information and patient diagnostic test information. A plurality of treatment plans is presented to the physician from a predefined list of treatment plans, wherein each of the plurality of treatment plans is comprised of at least one of a medical test, a medical procedure, a prescription, a pre-certification, a school excuse or a work excuse, and wherein each of the plurality of treatment plans corresponds to at least one of the plurality of candidate diagnoses. A treatment plan is selected from the plurality of treatment plans. At least a portion the selected treatment plan is executed.

The present invention also provides for a method for facilitating patient care in an emergency room. Patient information is electronically transferred from a first location, proximate the emergency room, to a second location remote from the first location or to multiple remote locations simultaneously. The patient information is maintained by a health care provider at the first location wherein the transferred patient information does not include the patient's protected personal information. Using a common graphical user interface, the patient information is electronically received by a second health care provider at the second location or at multiple locations by multiple providers that could be involved in care simultaneously. In response to patient information, at least one of a notification or order associated with treatment of the patient is electronically sent, via the graphical user interface, from the second location to the first location or to multiple providers involved in care. The notification or order is automatically associated with the patient at the first location.

The present invention also provides for a method for electronic self auditing a health care provider's level of service provided to a patient during a patient encounter. The method is performed simultaneously as documentation is completed. Health care provider information is received, wherein the health care provider information includes at least one of patient history information, patient examination information, patient diagnosis information and physician treatment plan information. A level of service for a patient encounter, chosen by a physician, is received. An audited level of service for the patient encounter is determined electronically and automatically from the received health care provider information. The audited level of service is compared with the physician selected level of service. A warning is generated if the audited level of service does not equal the level of service selected by the physician.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain features of the invention.

In the drawings:

FIG. 1 illustrates a system used in connection with the present invention;

FIG. 2 illustrates an exemplary data entry form that may be used in connection with the present invention;

FIG. 3 illustrates an exemplary graphical user interface that may be used to enter patient history;

FIG. 4 illustrates an exemplary graphical user interface that may be used to schedule a procedure;

FIG. 5 illustrates an exemplary graphical user interface that may be used to order a prescription;

FIG. 6 illustrates an exemplary graphical user interface that may be used to send a message;

FIG. 7 illustrates an exemplary graphical user interface that may be used to facilitate emergency room care;

FIG. 8 illustrates an exemplary graphical user interface that may be used to facilitate emergency room care;

FIG. 9 is a flow chart illustrating a method of a preferred embodiment of the present invention;

FIG. 10 is a flow chart illustrating a method of a preferred embodiment of the present invention; and

FIG. 11 is a flow chart illustrating a method of a preferred embodiment of the present invention.

### DETAILED DESCRIPTION OF THE PREFERRED EMBODIMENT

Reference will now be made in detail to the preferred embodiment of the present invention, examples of which are illustrated in the accompanying drawings. Wherever possible, the same reference numbers will be used throughout the drawings using the same or like parts or steps.

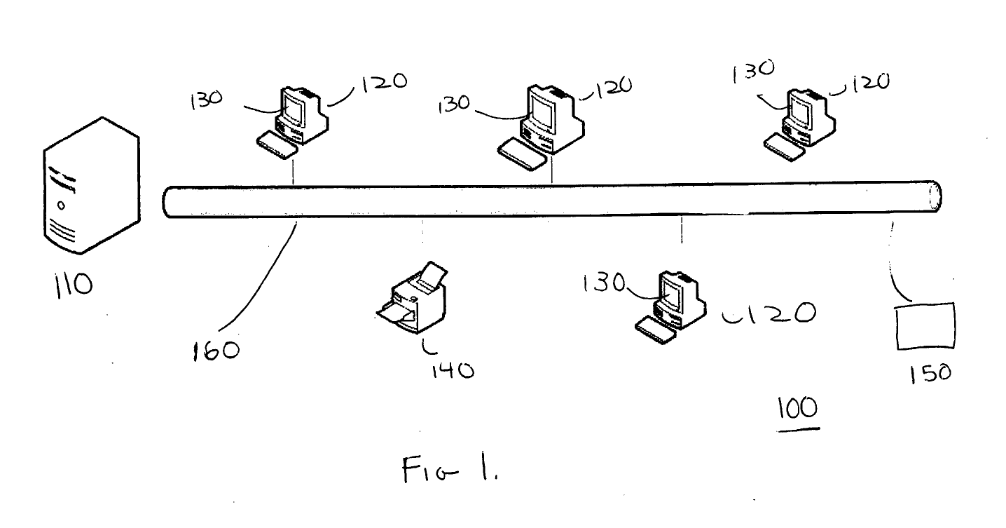

FIG. 1 illustrates a system for Electronic Medical Records (“EMR”) as described methods of the present invention. System 100 includes a database server 110, a plurality of user terminals 120, a graphical user interface 130 (“GUI”), a plurality of scanners 140, a plurality of printers 150 connected by a network 160. The database server stores all clinical information related to the evaluation and treatment of patients such as patient records, as patient notes, and patient templates in electronic form. The patient template has standard fields for entry of text related to the patient and the medical concern. Examples include new patient knee exam, established patient knee exam, patient heath questionnaire, or patient health history. Users can also create templates. The plurality of user terminals 120 may be located at an office of a healthcare provider or a location remote from the office of a healthcare provider or at a user location. The GUI 130 runs on each user terminal enabling users to enter patient history information, patient examination information and patient diagnostic test information. The GUI 130 also enables the user to receive a treatment plan for a patient based on the patient information. The GUI 130 also enables a user, remote from a healthcare provider location, to receive patient information for a patient at a different location. Furthermore, the GUI 130 enables the remote user to send a patient treatment plan, for a patient at a different location, in response to the patient information. The plurality of user terminals 120, scanner 140 and printers 150 maybe be located at an office of a healthcare provider. The database server 110, scanner 140 and plurality of user terminals 120 are connected via a local area network 160 using a common communication line or wireless link or a wide area network.

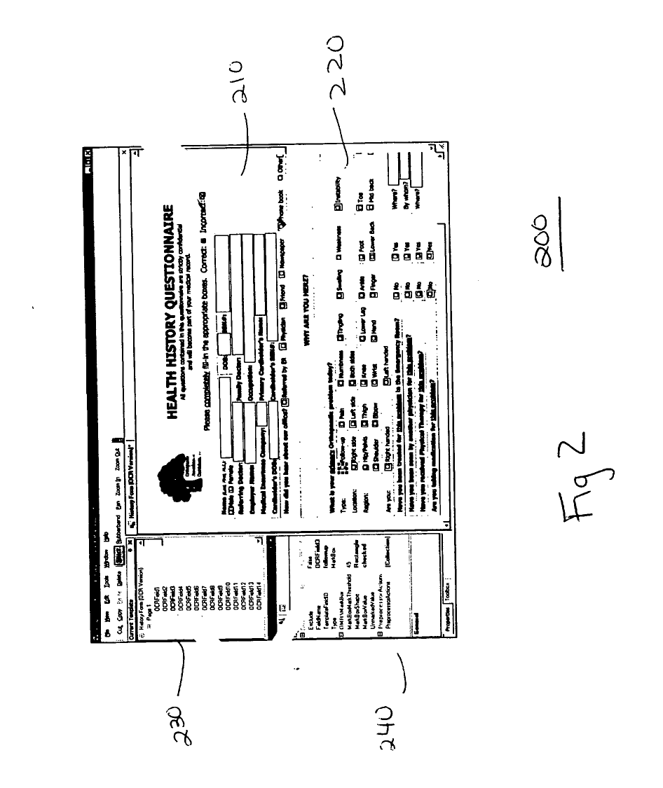

The present invention provides for an automated method for generating a treatment plan for a patient. The patient history information may be provided to the physician in electronic form via two methods, First the patient history may be entered in electronic form at a user terminal using a web browser to access the GUI. The patient may entered the patient history information via the GUI from a user terminal located within a practice or a user terminal located anywhere. For a user terminal at any location, the patient must first create a patient account and assign a unique username and password. The patient history also may be manually entered on a paper based form, scanned into an electronic format, imported into the EMR system and mapped to a patent history template. As illustrated in FIG. 2, the patient information is manually entered in the text input area 210 and health problem area 220 of a paper based form 200. These text input area 210 and health problem area 220 are mapped to corresponding text areas 230 and health problem areas 240 in a patient history template. The patient information is mapped into an electronic format via optical character recognition which translates the information on the paper form into text as if the physician had dictated the information. The patient history may be entered by the patient or a healthcare provider staff member. The patient information is then automatically sent to the database server and stored. After the patient information is entered into a database, the appropriate practice associated with the patient is identified and the patient history is entered into the practice's patient history form. At the practice, the patient history is either automatically downloaded into the practice database or downloaded, printed and then manually entered into the practice database. Once the healthcare provider receives the patient history in electronic form, the healthcare provider may review, edit or add information to the patient history, stored in the database, from any site where the physician has access to the system. A plurality of healthcare providers, associated with a practice having multiple locations, may access the system via the network.

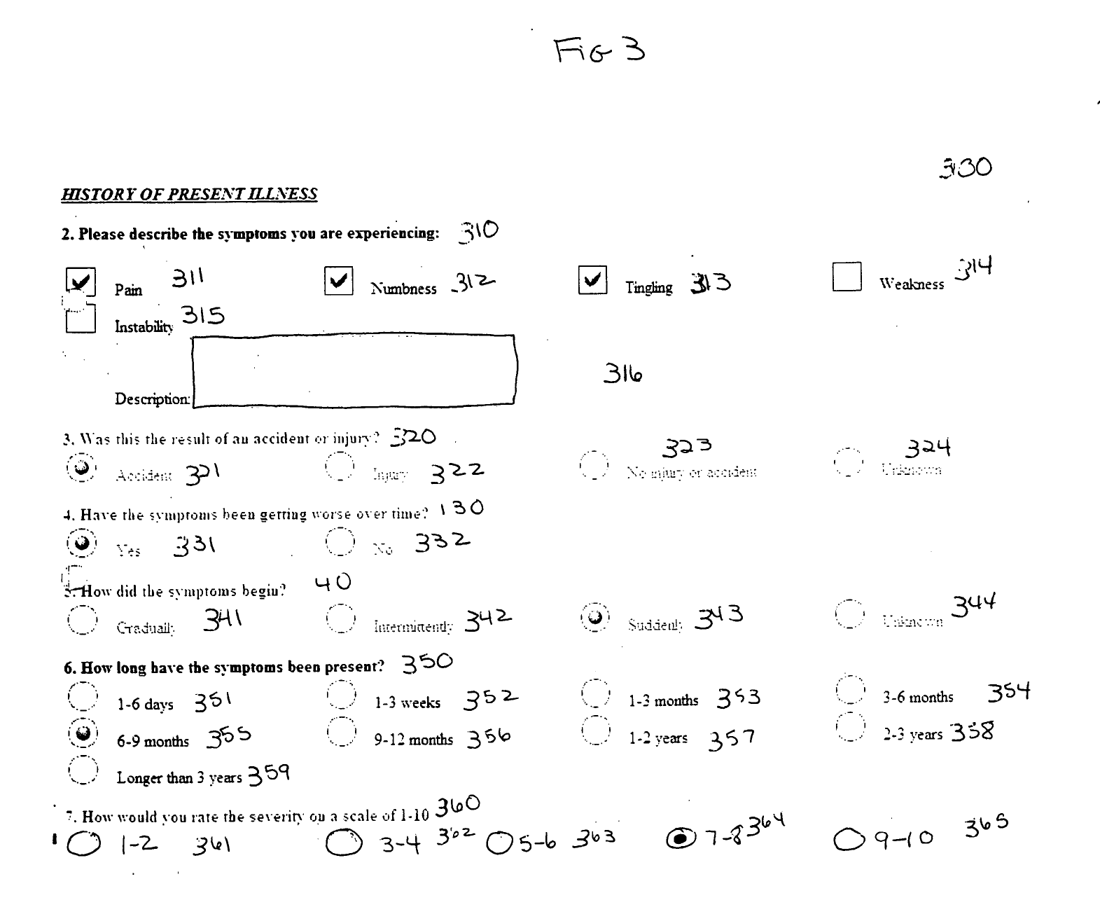

FIG. 3 illustrates an exemplary GUI or template which is used to provide patient history information to the healthcare provider in an electronic form. (Is this a template?) The healthcare provider may be comprised of a physician, technician, physical therapist, medical assistant, nurse or phlebotomist. The patient history field screen contains a symptom field 310, a result field 320, a symptom progress field 330, a symptom appearance field 340, a symptom time field 350 and symptom severity field 360. In the symptom field 310, the patient is asked to describe the symptoms he/she is experiencing as pain 311, numbness 312, tingling 313, weakness 314, or instability 315. If none of the pre-selected symptoms apply, the patient can enter a description 316 detailing the symptoms for which he/she is seeking treatment. In the result field, 320, the patient is then asked whether the symptoms are a result of an accident 321, an injury 322, no injury or accident 323 or an unknown source 324. In the progress field 330, the patient is asked to indicate whether the symptoms have gotten worse over time. In the symptom appearance field, the patient must identify whether the symptoms began gradually 341, intermittently 342, suddenly 343, or whether they are unknown 344 to the patient. In the symptom time field 350 the patient must identify how long the symptoms have been present in terms of days 351, or weeks 352, months 353, 354, 355, 356 or years 357, 358, and 359. In the symptom severity field, the patient is then asked to rate the severity on a scale of 1 through 10 in pain increments of 2. For the example illustrated in FIG. 3, the patient has indicated he/she is experiencing pain 311, numbness 312 and tingling 313. The symptoms were the result of an accident 321 and have grown worse over time 331. The patient's symptoms began suddenly 343 and have been present for 6-9 months 355. On a severity scale of 1-10, the patient ranks the severity as 7-8 364.

In addition to the patient history, the healthcare provider may also add examination information in electronic form collected during an examination of the patient using the common GUI. Any patient diagnostic test results are also entered in electronic form to the database via the common GUI. From the patient history information, patient examination information and patient diagnostic test information, a plurality of candidate diagnosis are then automatically selected for the patient. An algorithm is used to analyze the patient information to select a diagnosis. The diagnosis is then check against absolute negatives and enhancers and the plurality of treatment plans is selected. The healthcare provider is then presented a plurality of treatment plans from a pre-defined list of treatment plans based on the selected diagnosis. Each of the plurality of treatment plans corresponds to at least one of a plurality of candidate diagnoses. At least one of the plurality of treatment plans corresponds to a customized treatment plan that is based on individualized preferences of a physician using the common user interface. Within each treatment plan, a plurality of order entries are defined. These order entries may be comprised of scheduling medical tests and medical procedures appropriate for the patient diagnosis or it may also involve a prescription plan, which fills prescriptions for medication, physical therapy. The order entry may also involve a pre-certification message if required. Pre-certification messages may be needed in the instances of hospitalization or surgery. The treatment plan may also include a school excuse or a work excuse, ICD-9 and CPT billing codes. After a treatment plan is selected, at least a portion of the selected treatment plan for the patient is then executed. The healthcare provider may execute all orders at one time or may execute each order one at a time. The order execution is initiated and documented in the patient's file history.

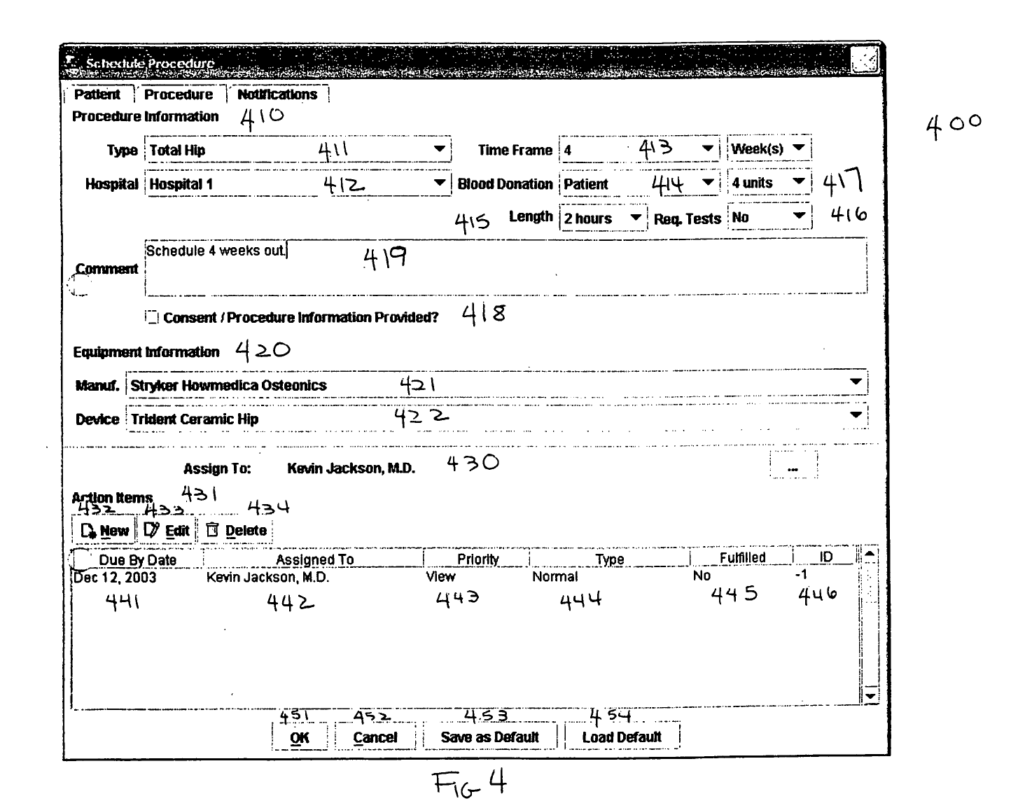

FIG. 4 illustrates an exemplary GUI used to schedule procedures as part of the patient treatment plan. The schedule procedure field screen 400 contains a procedure information field 410, an equipment information field 420 and an assignment field 430. In the procedure information field 410, the healthcare provider enters the type of procedure 411 the patient will require, the hospital where the procedure will be performed 412, the time frame 413 of the procedure, whether any blood donation 414 is required and the number of blood units required 417, the length of the procedure 415, and any required tests 416. The healthcare provider may enters a comment 419 related to the procedure. The healthcare provider is asked to indicate whether consent 418 is required for the procedure. In the equipment information field 420, the healthcare provider enters the type of equipment 422 necessary for the particular procedure for which the patient has been scheduled. For example, the healthcare provider may enter the manufacturer 421 of the equipment required and the name of the medical device 422. In the assignment field 430, the procedure is assigned to a specified physician 430. Certain action items must also be entered such as new items 432, the editing of any action items 433, and the deletion 434 of any action items. The action items could include approve the order, sign the order, schedule an appointment or schedule a procedure. A summary of the procedure is also provided indicating the due date 441, the physician the procedure is assigned to 442, the priority of the procedure 443, the type 444, and whether the procedure has been fulfilled 445. The healthcare provider then must either okay the procedure, cancel the procedure information, save or load default information. For the example illustrated in FIG. 4, the physician has scheduled a total hip replacement procedure 411 in Hospital 1 412 in four weeks 413, where the patient 414 will donate four units of blood 417, the hip replacement procedure taking two hours 415 and requesting no tests 416. The physician has added the comment 417 to schedule the procedure in four weeks. The physician has entered in the equipment information field 420, a trident ceramic hip 422 from Stryker Howmedica Osteonics 421. The assigned physician is Kevin Jackson, M.D 430.

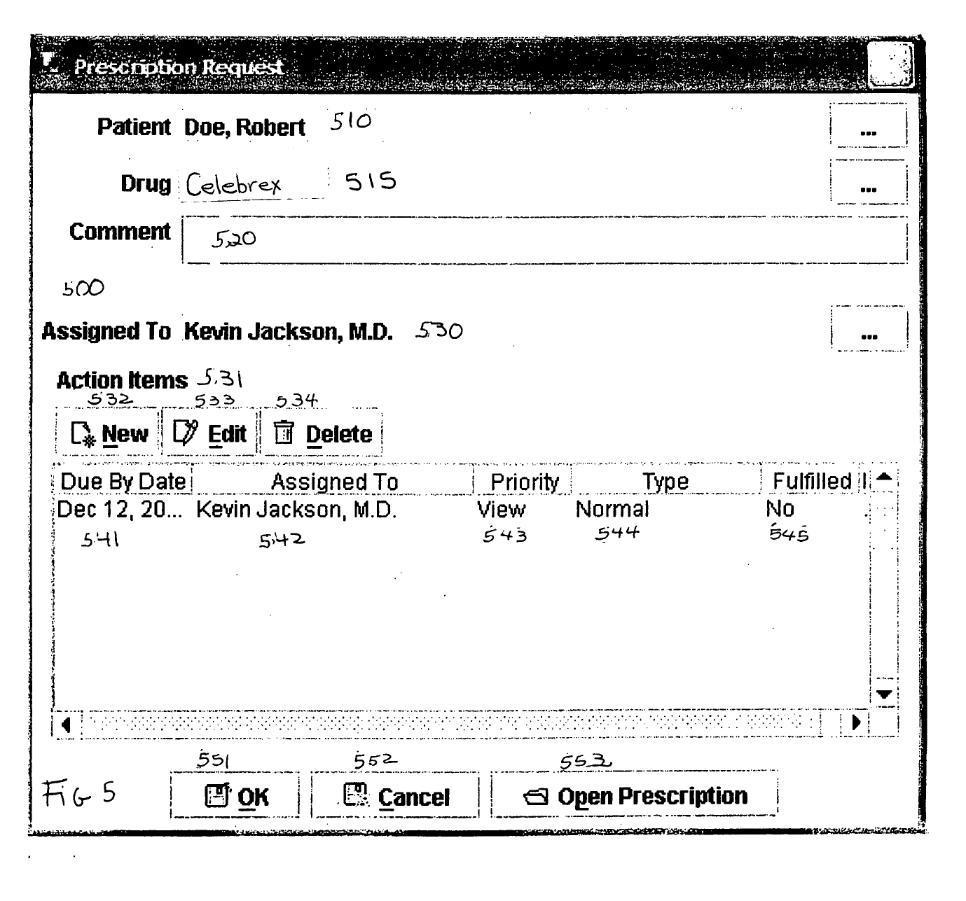

FIG. 5 illustrates an exemplary GUI for a prescription request. As illustrated in FIG. 5, the prescription request screen 500 contains a patient field 510, a drug field 515, a comment field 520, an assigned position field 530, an action item field 531, a new action item 532, an edited action 533, or deleted action item 534 The prescription request screen 500 also illustrates a summary field indicating the due date 541, the assigned physician 542, priority 543, the type of plan 544, and whether the prescription has been fulfilled 545. The physician may okay the prescription plan 551, cancel the plan 552, or open the prescription plan 553. The prescription plan may include such items as the dosage, units, dosing quantity or frequency. In the example illustrated in FIG. 5, the patient, Robert Doe 510, is prescribed Celebrex 515, the assigned physician is Kevin Jackson 530.

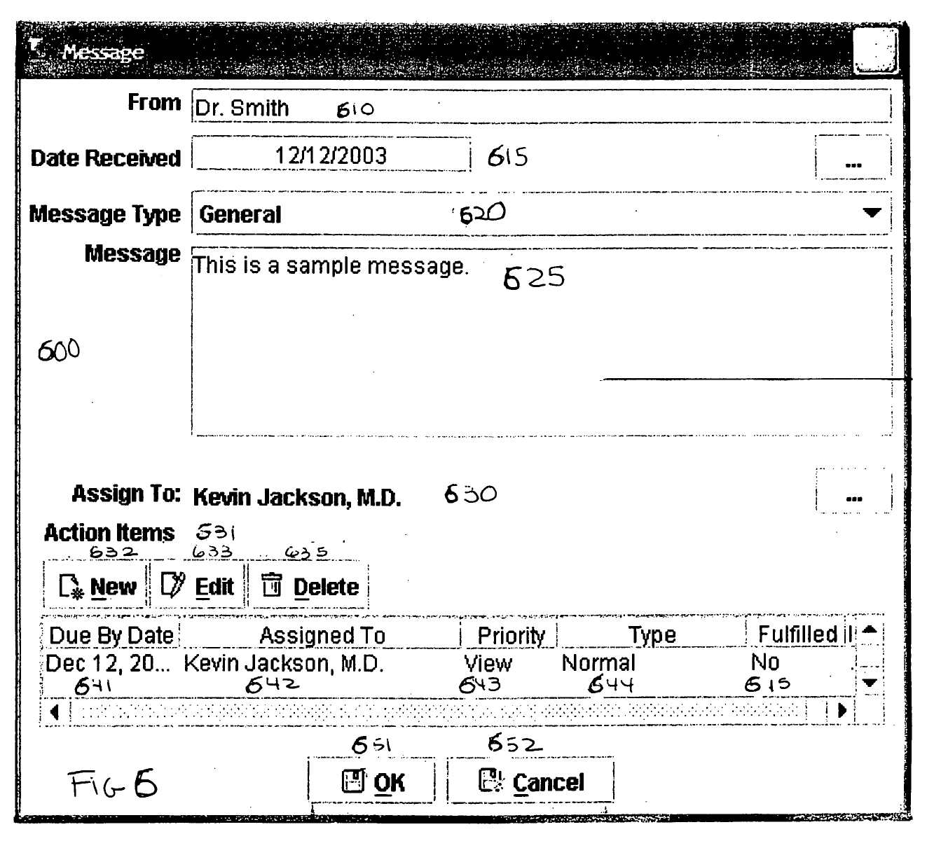

The method of the present invention also provides for the transmittal of messages to external patients, doctors, educational information, and/or reminders to patients and doctors. It also provides for internal messages and orders sent to internal physicians or other healthcare providers. FIG. 6 illustrates an exemplary GUI used for the transmittal of messages. In the message screen 600, the from field 610 indicates the originator of the message as well as the date received 615. The message type 620 indicates whether the message is a general type or phone reminder. The message field 625 displays the message from the author of the message to the treating physician or the healthcare provider attending to the medical procedure. In the assigned field, the treating physician is indicated 630. The action item field indicates any new action items 632, the editing of an action item 633 and the deletion 634 of an action item. The summary screen indicates the due date 641 of the procedure, the assigned physician 642, the priority 643 of the procedure, and the type 644 of the procedure.

After a treatment plan has been established for the patient, the patient is issued a card with the medical information such as medication history or surgical history. A medical identification card and an apparatus for generating a medical identification card are described in copending application Ser. No. 10/396,075 filed Mar. 25, 2003, application Ser. No. 10/437,486 filed May 14, 2003 and application Ser. No. 10/697,791 filed Oct. 30, 2003, and incorporated herein by reference. CPT and ICD/9 as well as other codes like Q and L are sent to the billing system. The invention also provides for a feedback loop, which evaluates the treatment plan and sets up reminders if a particular task of the treatment plan is not completed in a specified time. Once results of any patient testing or procedures are completed, a conformation is issued and the assigned or healthcare provider staff of the treatment plan is notified.

This automated method for generating a treatment plan for a patient may be used to develop standardized treatment plans for particular conditions. Examples include a specialized patient management system for osteosclerosis or diabetes.

The present invention also provides for a method for facilitating patient care in an emergency room situation. In many situations, a patient is examined and tests conducted at an emergency room proximate to a first healthcare provider location. The patient information collected at the emergency room is maintained by a healthcare provider at the first location. It is sometimes necessary for a healthcare provider, at a second location remote from the first location, to review the patient information or test results and order a treatment plan. To facilitate emergency room patient care, the patient information from the first healthcare provider location, which is proximate to an emergency room, is electronically transferred to a second healthcare provider at a second location. The information may also be electronically transferred to one or more second health care providers at multiple second locations. In order to maintain the patient's privacy, the transferred patient information does not include the patient's protected personal information when the patient information is electronically transferred to the one or more second locations. The second healthcare provider at the second location electronically receive the patient information. Multiple healthcare providers at multiple locations that may be simultaneously involved in the patient's care may also electronically receive the patient information. In response to reviewing the patient information, a notification or treatment order, which is associated with the treatment of the patient, is electronically transferred from the second healthcare provider location to the first location. The notification or treatment order may also be electronically transferred to multiple providers who are involved in the patient's care. The notification or treatment order is then automatically associated with the emergency room patient located at the first healthcare provider location.

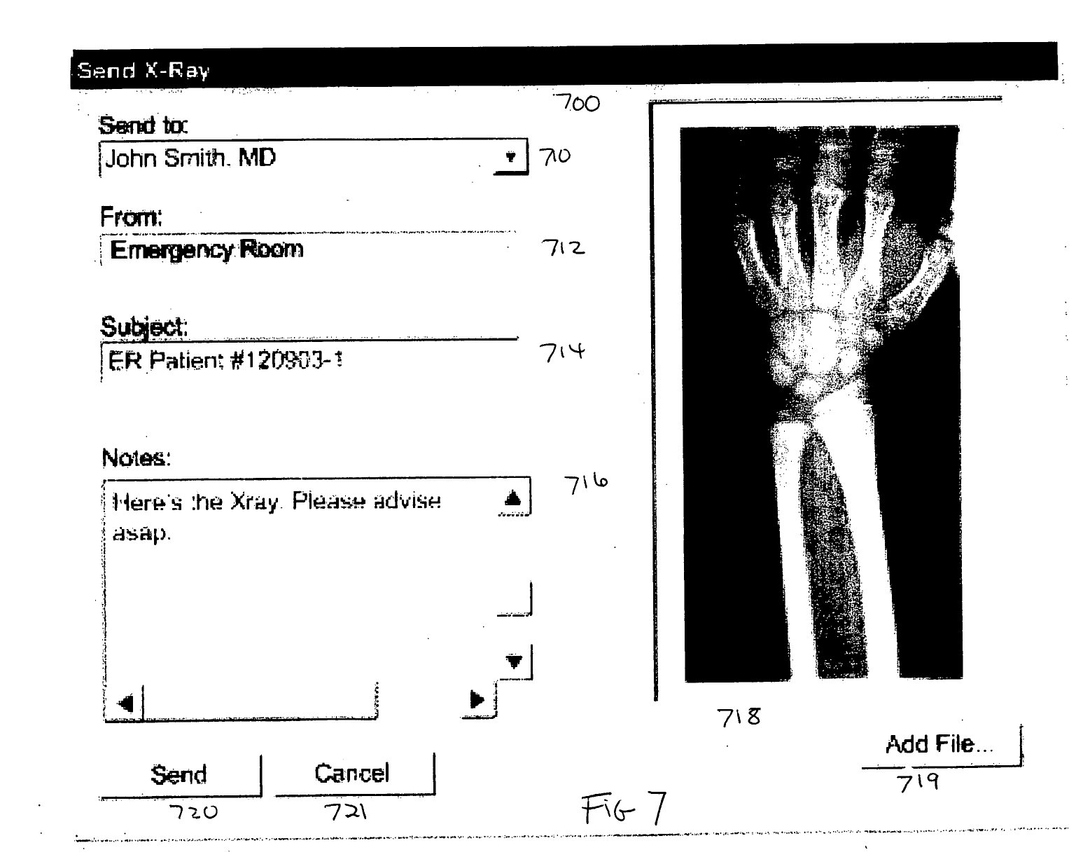

FIG. 7 illustrates an exemplary GUI used to send patient information from a first location to a remote location. As illustrated in FIG. 7, the send information screen 700 contains a send to field 710, a from field 712, subject field 714 in which a patient number is assigned to the patient. This patient number does not contain the patient's protected personal information to ensure the patient's privacy. The healthcare provider at the first location may enter comments in the notes field 716 for the second healthcare provider at the second location. The patient information field may contain a variety of information such as patient's x-ray. The healthcare provider may then elect to send 720 or cancel 721 the transfer of information before it is sent to the second healthcare provider at the second location. In the example of FIG. 7, an x-ray image of a hand, wrist and forearm, for patient ER Patient No. 120903-1, is sent from an emergency room at a first location to Dr. John Smith, at a second location, requesting advice as soon as possible.

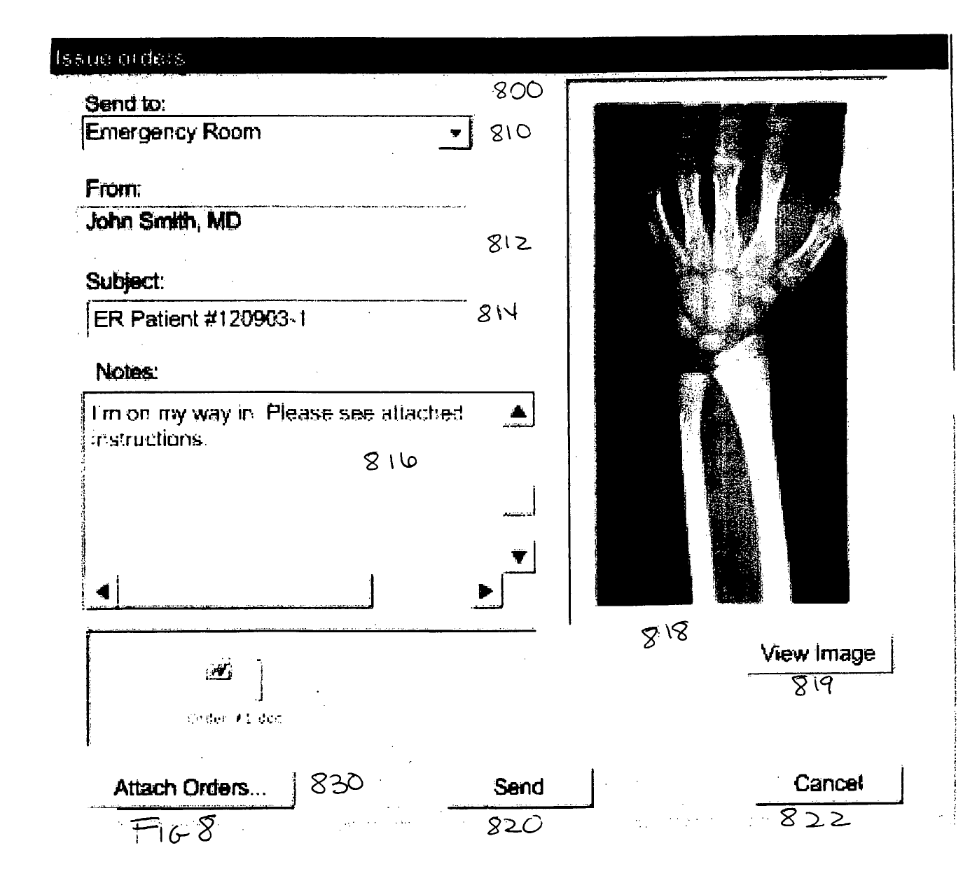

FIG. 8 illustrates an exemplary GUI used to electronically issue orders from the remote location to the first healthcare provider location. As illustrated in FIG. 8, the issue order screen contains a send to field 810 in which the information may be sent to an emergency room or other treatment centers within a practice, a from screen 812, a subject screen 814 which contains the patient number without providing the patient protected personal information to ensure the patient's privacy. The notes screen 816 contains information from the second healthcare provider at the remote location indicating the second healthcare provider's instructions. The patient information field 818 contains the patient information which was transferred to the remote location and includes such information as x-ray images, lab reports or patient documents. The healthcare provider at the remote location may attach an order 830 to the message wherein the order is transferred to the healthcare provider at the first location. In the example illustrated in FIG. 8, an order is sent electronically from Dr. John Smith, at a second location, to the emergency room at a first location for Patient No. 120903-1. Dr. Smith as advised the emergency room that he is on his way and has attached an order describing the patient's prescribed treatment.

In a preferred embodiment, a method for facilitating patient care in an emergency room may comprise the electronic transfer of a representation of an x-ray film image. With reference to FIGS. 7 and 8, a healthcare provider in the emergency room takes an x-ray image(s) at the first location which is sent to a second healthcare provider or multiple healthcare providers at a second location. When the x-ray film image is transferred from the first location proximate to the emergency room, a message such as an e-mail message is sent to the healthcare provider or multiple healthcare providers located at a second location. Once the second healthcare provider receives the e-mail message, the second healthcare provider needs to only click on the link to view the x-ray image. Once the healthcare provider has viewed the x-ray film image at the remote location, the healthcare provider can then determine a treatment plan for the patient. If the healthcare provider determines that treatment is in order for the patient, the healthcare provider can activate, at the second location, orders and/or notifications which are sent electronically to the emergency room at the first location. The emergency room receives the orders and/or notifications which may include various orders that are electronically signed. The emergency room then begins to prepare the patient for treatment as outlined in the orders and/or notifications. The healthcare provider at the second location can also activate a sales representative link or a supervisor link to order equipment needed for the appropriate order. Once this message is sent to the sales representative or hospital supervisor, those individuals can then proceed to secure any equipment such as implants needed for the procedure. From the second location, the second healthcare provide can also activate a notification for anesthesia and assistance to assist in the patient treatment. Once this information is sent electronically, the healthcare providers at the first location they may activate the required assistance, anesthesia or other medication. The healthcare provider at the second location may also send notification to its billing office so that the office can add this treatment plan to its database and check on the appropriate billing codes.

The method of the present invention also provides for an electronic self auditing of a healthcare provider's level of service provided to a patient during a patient encounter. This self auditing is done simultaneously as the patient documentation is completed. Health care provider information is received from the database, wherein the health care provider information includes at least one of patient history information, patient examination information, patient diagnosis information and physician treatment plan information. A level of service for the patient encounter is received, from the database, where the level of service is chosen by the physician, wherein the level of service comprises minimal risk, low risk, moderate risk or high risk. From the healthcare provider information, and audited level of service for the patient encounter is electronically and automatically determined by the method of the invention. Next, the audited level of service for the patient encounter is then compared with the physician selected level of service for the patient encounter. If the audited level of patient service does not equal the level of service selected by the physician, then a warning is generated to the physician. An algorithm is used to select the audited level of service. The algorithm considers the patient history, physical examination and medical decision making. For the patient history, three elements are considered: history of present illness, review of systems; and past medical, family and social history. For the physical examination, the number of systems/body areas that are examined are considered. For the medical decision making, the number of problems/diagnoses, amount of data and risk is considered.

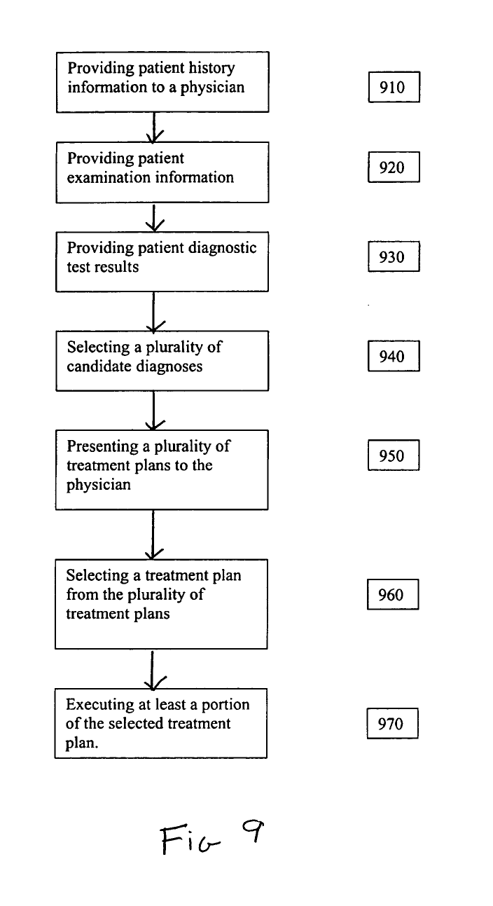

With reference to FIG. 9, a flow chart illustrating a preferred embodiment of the method for generating a treatment plan for a patient, is shown. In step 910, a patient history information is provided to a physician in electronic form. In step 920, patient examination information is provided in electronic form. In step 930, patient diagnostic test results is provided in electronic form. In step 940, a plurality of candidate diagnoses is automatically selected using the patient history information, patient examination information and patient diagnostic test information. In step 950, a plurality of treatment plans is presented to the physician from a predefined list of treatment plans, wherein each of the plurality of treatment plans is comprised of at least one of a medical test, a medical procedure, a prescription, a pre-certification, a school excuse or a work excuse, and wherein each of the plurality of treatment plans corresponds to at least one of the plurality of candidate diagnoses. In step 960, a treatment plan is selected from the plurality of treatment plans. In step 970, at least a portion the selected treatment plan, is executed. Steps 920 through 950 are performed using a common user interface.

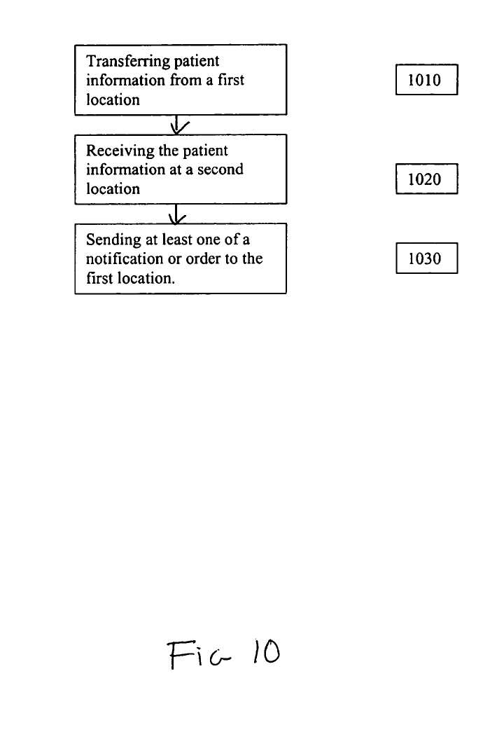

With reference to FIG. 10, a flow chart illustrating a preferred embodiment of the method for facilitating patient care in an emergency room, is shown. In step 1010, patient information is electronically transferred, from a first location proximate the emergency room to a second location remote from the first location or to multiple locations simultaneously. The patient information is maintained by a health care provider at the first location and wherein the transferred patient information does not include the patient's protected personal information. In step 1020, the patient information is electronically received by a second health care provider at the second location or at multiple locations by multiple providers that could be involved in care simultaneously. In response to patient information, at least one of a notification or order associated with treatment of the patient is electronically sent from the second location to the first location or to multiple providers involved in care, in step 1030. The notification or order is automatically associated with the patient at the first location. Steps 1020 and 1030 are performed using a common user interface..

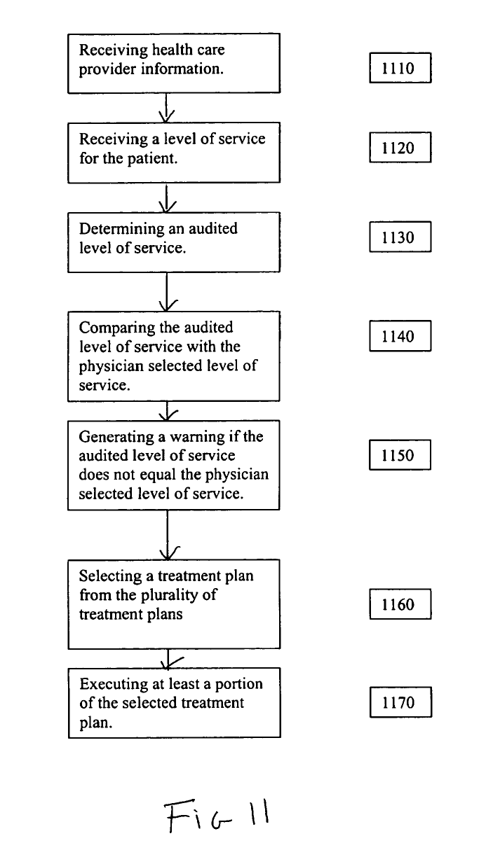

With reference to FIG. 11, a flow chart illustrating a preferred embodiment of the method for electronic self auditing a health care provider's level of service provided to a patient during a patient encounter, is shown. The method is performed simultaneously as documentation is completed. In step 1110, health care provider information is received, wherein the health care provider information includes at least one of patient history information, patient examination information, patient diagnosis information and physician treatment plan information. In step 1120, a level of service for a patient encounter chosen by a physician is received. In step 1130, an audited level of service for the patient encounter is determined electronically and automatically from the health care provider information received in step 1110. In step 1140, the audited level of service is compared with the physician selected level of service. In step 1150, a warning is generated if the audited level of service does not equal the level of service selected by the physician.

While the principles of the invention have been described above in connection with the specific apparatus and associated methods set forth above, it is to be clearly understood that the above description is made only by way of example and not as a limitation on the scope of the invention as defined in the appended claims.

1. An automated method for generating a treatment plan for a patient comprising the steps of:
(a) providing patient history information to a physician in electronic form;
(b) providing patient examination information in electronic form;
(c) providing patient diagnostic test results in electronic form
(d) automatically selecting a plurality of candidate diagnoses using the patient history information, patient examination information and patient diagnostic test information;
(e) presenting a plurality of treatment plans to the physician from a predefined list of treatment plans, wherein each of the plurality of treatment plans is comprised of at least one of a medical test, a medical procedure, a prescription, a pre-certification, a school excuse or a work excuse, and wherein each of the plurality of treatment plans corresponds to at least one of the plurality of candidate diagnoses;
(f) selecting a treatment plan from the plurality of treatment plans; and
(g) executing at least a portion the selected treatment plan, wherein steps (b)-(e) are performed using a common user interface.

2. The method of claim 1, wherein steps (a)-(e) are performed using a common user interface.

3. The method of claim 1, wherein providing patient history to a physician in electronic form further comprises:
manually entering patient history on a paper based form;
scanning the patient history on the paper based form;
importing the patient history wherein the patient history is translated into an electronic format through optical character recognition; and
mapping the patient history in the electronic format to a patent history template.

4. The method of claim 1, wherein at least one of the plurality of treatment plans corresponds to a customized treatment plan that is based on individualized preferences of a physician using the common user interface.

5. A method for facilitating patient care in an emergency room comprising the steps of:
(a) electronically transferring patient information, from a first location proximate the emergency room to a second location remote from the first location or to multiple locations simultaneously,
wherein the patient information is maintained by a health care provider at the first location and wherein the transferred patient information does not include the patient's protected personal information;
(b) electronically receiving the patient information by a second health care provider at the second location or at multiple locations by multiple providers that could be involved in care simultaneously;
(c) in response to patient information, electronically sending at least one of a notification or order associated with treatment of the patient from the second location to the first location or to multiple providers involved in care, wherein steps (b)-(c) are performed using a common user interface; and
wherein the notification or order is automatically associated with the patient at the first location.

6. The method of claim 5, wherein the electronically transferring of step (a) comprises transferring a representation of an x-ray film image.

7. A method for electronic self auditing, simultaneously as documentation is completed, a health care provider's level of service provided to a patient during a patient encounter comprising the steps of:
(a) receiving health care provider information, wherein the health care provider information includes at least one of patient history information, patient examination information, patient diagnosis information and physician treatment plan information;
(b) receiving a level of service for a patient encounter chosen by a physician;
(c) electronically and automatically determining from the health care provider information received in step (a), an audited level of service for the patient encounter;
(d) comparing the audited level of service with the physician selected level of service; and
(e) generating a warning if the audited level of service does not equal the level of service selected by the physician.
